(19) United States
(12) Patent Application Publication
(10) Pub. No.: US 2009/0047649 A1
(43) Pub. Date: Feb. 19, 2009

(54) Secure remote testing system and method

(76) Inventors: Coy V. Ison, Price, UT (US); Cody Spendlove, Spanish Fork, UT (US); Dan Matthews, Orondo, WA (US); Don Fournier, Scottsdale, AZ (US); Ryan Hartley, Providence, UT (US)

Correspondence Address: DAVID R. MCKINNEY, P.C., P.O. BOX 1460, SANDY, UT, 84091, US

(21) Appl. No.: 11/891,786

(22) Filed: Aug. 13, 2007

(51) Int. Cl. G09B 7/00; G06F 21/20

(52) U.S. Cl. 434/350; 726/16; 726/17

(57) ABSTRACT

Various embodiments of a secure remote testing system and method are described and claimed.

### BACKGROUND

1. Field of the Invention

The present invention relates generally to systems for remote administration of academic and other testing. More particularly, the present invention relates to a novel system and method whereby academic and other examinations can be securely administered to students via a computer terminal at any location.

2. Related Art

“High stakes” testing and assessment, such as high school graduation exams and the like, are now widely used to measure the progress of students at many levels. In order to streamline the process and reduce the cost of administration of these types of examinations, the use of computerized testing systems is increasing, especially in view of advances in the power and capabilities of personal computer systems, and the decrease in the cost of computers.

While computerized examinations as such are not new, their administration in a secure way can be cumbersome and expensive. For example, many computer-administered examinations require specialized software to be loaded onto individual computers or networks, and these often require that a technician work on every station to add software applications and adjust other factors. Additionally, requirements of test security and fairness can require that a test administrator be present to start and stop each test, to ensure that the results are properly received, and that test information is not improperly taken or sent away from the testing location. All of these requirements tend to increase the cost and complexity of computer-administered testing, and tend to decrease the desirability of it.

### SUMMARY

It has been recognized that it would be advantageous to develop a remote testing system that is easy to administer and that requires minimal direct intervention on the part of test administrators or computer technicians.

It has also been recognized that it would be advantageous to have a remote testing system that is simple to use.

It has also been recognized that it would be advantageous to have a remote testing system that is secure and reliable.

In accordance with one embodiment thereof, the present invention provides a system for administering a standard test to be taken during a testing session by a remote user at a personal workstation having access to a communication network. The system includes a testing website, a secure server at the testing website, and computer software provided to the remote user by the sponsor of the standard test in advance of the testing session. The testing website is maintained by the sponsor of the standard test and is accessible through the communication network. The secure server is dedicated to supplying inquiries from the standard test through the communication network to the remote user and to processing responses to the inquiries provided by the remote user through the communication network. The computer software is receivable in the personal workstation at the convenience of the remote user to initiate the testing session, and the computer software preempts operation of the personal workstation for any purpose other than to enable the remote user to participate in the administration of the standard test.

In accordance with another aspect thereof, the invention provides a computer system for administering a standard test to be taken during a testing session by a remote user at a personal workstation having access to a communication network, the computer system comprises a secure server accessible through the communication network, the secure server being dedicated to supplying inquiries from the standard test to the remote user and to processing responses of the remote user to the inquiries. The system also includes means for deactivating preexisting computer software on the personal workstation during the testing session, means for operating the personal workstation during the testing session, and means for contacting the secure server from the personal workstation during the testing session.

In accordance with yet another aspect thereof, the invention provides a method for administering a standard test to be taken during a testing session by a remote user at a personal workstation having access to a communication network. The method includes the steps of (a) maintaining a secure server accessible through the communication network, the secure server being dedicated to supplying inquiries from the standard test to the remote user and to processing responses of the remote user to the inquiries; (b) enrolling the remote user to receive and to respond at the personal workstation to the inquiries from the standard test during the testing secession; and (c) supplying to the remote user in advance of the testing session computer software receivable into the personal workstation at the convenience of the remote user to initiate the testing session, the computer software being capable of preempting operation of the personal workstation for any purpose other than to enable the remote user to participate in the administration of the standard test.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a schematic diagram of one embodiment of a secure remote testing system according to the present disclosure;

FIG. 2 is a schematic diagram of an alternative embodiment of a secure remote testing system according to the present disclosure;

FIG. 3 is a flowchart outlining the steps in one embodiment of a method for administering a remote test using a secure remote testing system according to the present disclosure;

FIG. 4 is a flowchart outlining the steps in one embodiment of a method for administering a remote test using a secure remote testing system according to the present disclosure; and

FIG. 5 is a block diagram of one embodiment of the steps in substituting the overlap operating system and initiating access to the secure server.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

As noted above, “high stakes” testing, such as high school graduation exams and other exams, are now frequently administered by computer. However, computer administration of these exams can present some costs and drawbacks that limit their use and effectiveness, as well as their security and reliability. Advantageously, the inventors have developed a system for remotely administering tests that allows such exams to be securely administered via a computer terminal at any location. While computerized examinations are not new, this invention provides them in a unique way. The inventors' system and method does not require having test information or test software at a testing terminal or workstation location, and preempts the operating system of the testing terminal to run its own operating system as an overlap.

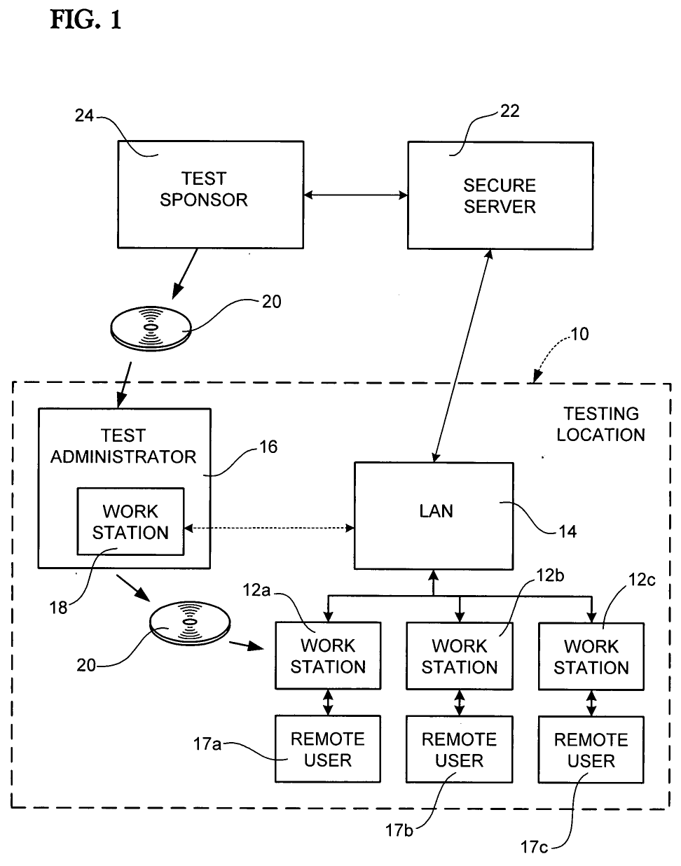

A schematic diagram of one embodiment of a secure remote testing system according to the present disclosure is provided in FIG. 1. In this embodiment, persons taking a test do so at a testing location 10 (e.g. a classroom, office, etc.) on a workstation 12 that can be one of several such workstations (labeled 12a-c) that are interconnected to a local computer network 14. The test administrator 16 can be a person or an organization—e.g. a school, a school district, or an individual teacher. The persons taking the test(s) are remote users 17. The test administrator generally provides a person who is present at the testing location to oversee the testing process. The test administrator can have access to an administrator workstation 18 that is also interconnected to the local area network. This can allow local supervision of workstation operation, and maintenance of the local network and workstations when needed.

The test administrator 16 provides software for each workstation to allow users to complete a test on the workstation. This software can be provided on a boot CD 20 (or other fixed medium, or via some other software transmission device or method) that can be loaded into each workstation 12. The boot CD can be loaded onto the local workstation by the remote user 17 (the test taker). There is no need to add software to a workstation or for a technician to deal with the individual workstation at all. This boot CD (or other system software transmission device) contains no test information, but temporarily preempts the operating system of the workstation with its own operating system, and includes a contact program, such as a restricted web browser. This places the normal operating system of the computer workstation into a background mode, and allows the boot CD's operating system to run on top of the other, as an overlap. Using this preempting operating system, the computer network 14 associated with the testing location is interconnected to a communications network (e.g. the Internet), which allows the web browser to connect to a secure web server (i.e. a “dark” server) 22, which communicates through the local network 14 to provide the test information from a remote location. The secure server can be part of its own local network, or it can stand alone.

The boot CD 20 can include all system software and drivers necessary to temporarily boot up the workstation (e.g. a Macintosh or PC). The boot CD can include an overlay operating system with a single restricted web browser application. The overlay operating system can be an open source system, such as Linux OS, or it can be programmed using other system software. The web browser can be limited to go to a single URL or range of addresses. Advantageously, there is no test information on the CD; it is only for access to the Internet and the secure server. The web browser can be a very simple, stripped down web browser. For example, the limited function browser can be stripped of functions such as email access, print screen, copy and paste, screen caps, printer drivers, etc., and can prevent access to other applications and other Internet sites. That is, the preempting operating system can limit IP access to a specific range or address, which allows connection only to the secure server 22. Additionally, for security purposes the operating system can be configured to use encryption (e.g. SSL encryption) of transmissions to and from the secure server.

The boot CD can also be limited by a date window tied to a testing date window. This allows the system to operate only for a limited time (e.g. a 2 hour test session) within a limited testing window (e.g. a 2 day testing window). This provides the convenience of allowing test takers to take the test at any time during the testing window. The boot CD can be configured to allow only one use, so that once it has been used to allow a test taker to take the test, it cannot be used again, and it cannot be used outside the testing window. The CD is only good during a particular testing window of time, after which it becomes useless. Likewise, the software on the disk limits the testing session, so that when the test session expires, the system automatically shuts down and forwards the test results to the secure server. This prevents any test taker from taking more time than others. After the test is complete, the test results are determined and retained by the secure server, and can be provided back to the test administrator, directly to the test taker (e.g. via the workstation 12), and in other ways.

Because the boot CD provides its operating system as an overlap, when the boot CD is removed from the computer at the end of the test (or automatically when the test session expires), the computer returns to its normal operating system. No test information is contained on the boot CD or retained on the workstation after the test is completed. A number of other security features can also be associated with the boot CD and the web server to ensure accuracy and to prevent tampering. For example, the testing system software can be configured to allow connections only from a specific IP address or range of addresses. As another security feature, the software can be configured to only allow connections during a testing window date or date range, and/or during a testing time window (e.g. 8 am to 4 pm). As yet another security feature, the system can be configured to establish a connection with a proxy server that then redirects the connection to the real testing server. Other security features can also be used.

The secure server is operated and maintained by a test sponsor 24. This secure server is a limited access server, and is manageable via the Internet with secure accounts and passwords to allow only the test sponsor to update and maintain it. It can have a hidden (i.e. unpublished) IP address and no DNS (domain name system). This prevents search engines or other Internet access systems from finding this server, allowing only those that have the IP address from accessing it. This server hosts all tests, questions and a testing database system, and runs specialized testing engine software to provide one or more tests. The test sponsor can be a testing organization, such as organizations that currently provide aptitude and achievement tests for schools and school districts. The test sponsor provides the testing information that is stored on the secure server, and also provides the operating system software (e.g. the boot CD 20) to the test administrator 16.

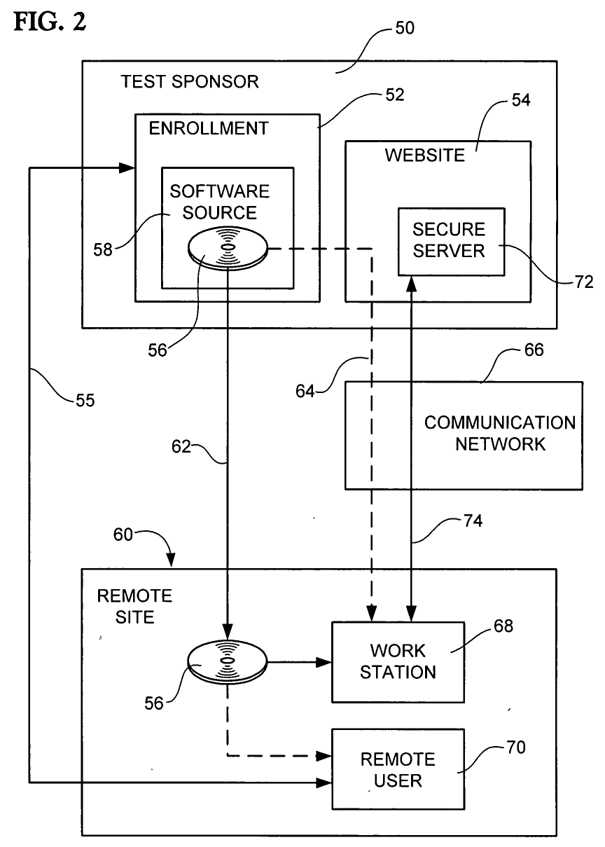

A schematic diagram of an alternative embodiment of a secure remote testing system according to the present disclosure is provided in FIG. 2. As this diagram indicates, the test sponsor 50 manages enrollment 52 for the test, and also manages the website 54 with the secure server. The enrollment aspect of the test sponsor's work generally involves authorizing a remote user 70 to take a given test (as indicated by solid line 55), and also involves providing the testing software (e.g. the boot CD 56) from a software source 58 to the remote testing site 60. While the boot CD can be physically transported to the remote testing site (e.g. via mail delivery) as indicated by the solid line 62, it is to be appreciated that the testing system software can be delivered in other ways. For example, as indicated by the dashed line 64, the testing system software can be delivered through the website 54 via a communications network 66, such as the Internet. This approach can simplify the delivery of the testing system software. At the remote site 60, the software is loaded onto the workstation 68, allowing the remote user 70 to take the test. The secure server 72 at the testing website 54 is dedicated to supplying inquiries from a standard test through the communication network 66 to the remote user 70, and to processing responses to the inquiries from the remote user provided through the communication network, as indicated by solid line 74.

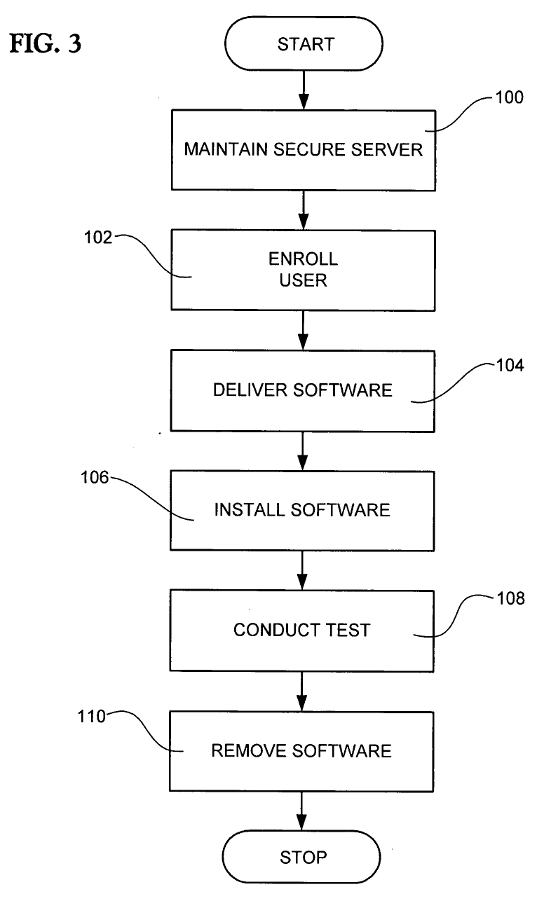

Viewing FIG. 3, in one embodiment of the method the initial work of the test sponsor involves maintaining the secure server (step 100), enrolling a user to take a test (step 102), then delivering the temporary operating system software (step 104). This software is then installed on the workstation (step 106), after which the test is administered (step 108). When the test is completed and the workstation is rebooted, the testing system software is removed (step 110) and the testing portion of the process is complete. It will be apparent that additional steps associated with grading the test and reporting results to the test taker and administrator are not depicted in this figure.

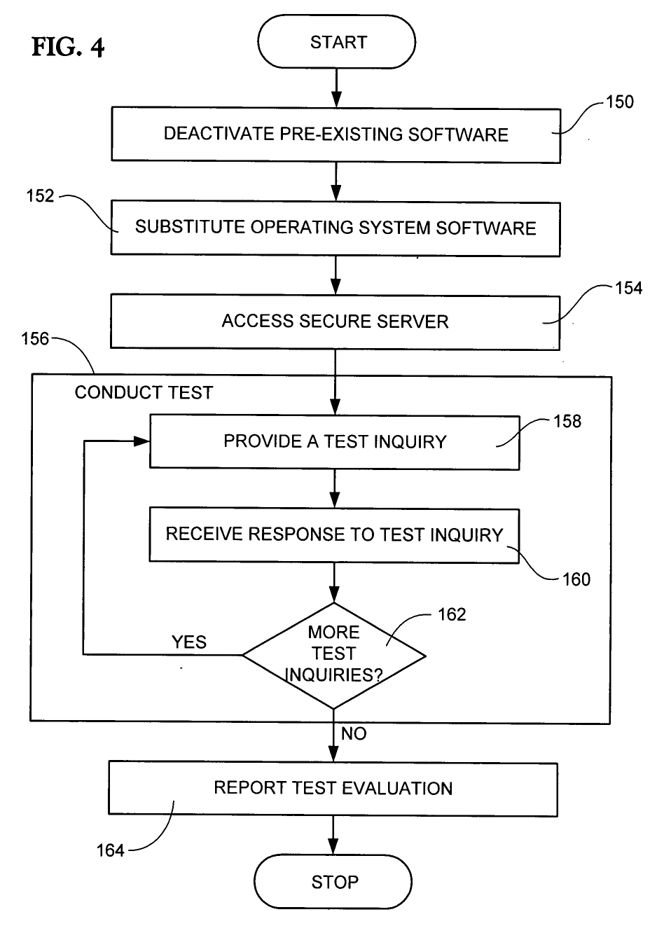

A more detailed diagram of one embodiment of the steps involved in installing the testing software and conducting the test is given in FIG. 4. When the software is initially installed, it first deactivates the preexisting software that is running on the workstation (step 150) and puts this software into a background or sleep mode. The system then substitutes its own operating system software (step 152), which provides the limited function web browser. The system then accesses the secure server (step 154), and proceeds to conduct the test (step 156).

It is to be appreciated that the testing software can provide test information in a variety of ways. As shown in FIG. 4, the system can download and provide a single test inquiry at a time (step 158), then receive the test taker's response to that inquiry (step 160). Following each response, the system can consider whether there are more test inquiries (step 162), and if so, return to step 158 and provide a subsequent test inquiry, and so on, until the test is complete. When there are no more test inquiries, the system can then compute and report an evaluation of the test (step 164), and the test is complete.

It is to be appreciated, however, that the test inquiries can be provided and responses received in other ways. For example, test inquiries can be provided in groups of multiple inquiries, or all at once, and regardless of how the inquiries are provides, the system can be configured to allow a test taker to skip questions and come back to them later, if desired. Other options are also possible, and will be apparent to those of skill in the art.

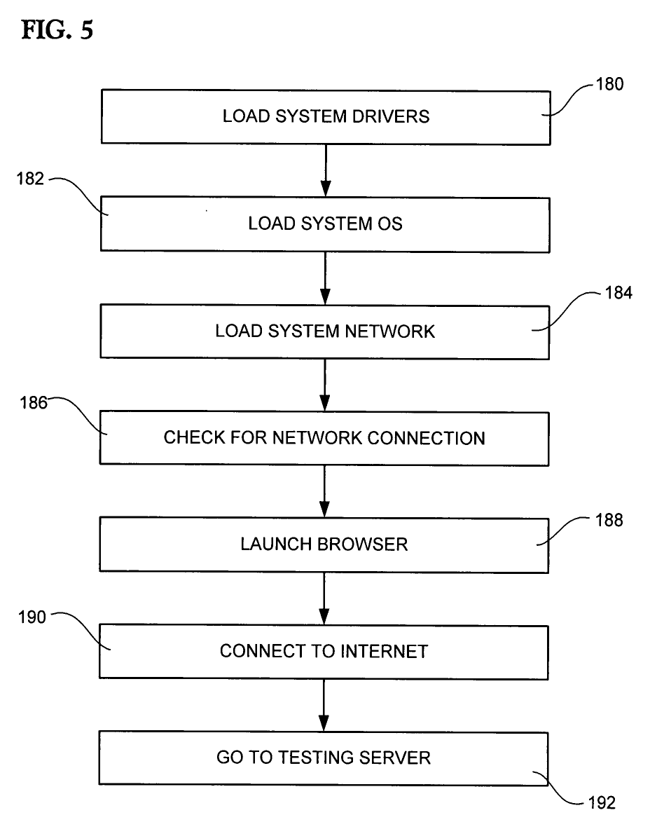

A more detailed or expanded chart of one embodiment of the steps involved in loading the overlap operating system (step 152 in FIG. 4) and establishing access to the secure server (step 154 in FIG. 4) is provided in FIG. 5. Once the boot CD (or other software source) is loaded onto the workstation, the system first loads the system drivers (step 180), loads the system OS (step 182), and loads the system network (step 184). Once these steps are completed, the new operating system can then check for a network connection (step 186) and launch its browser (step 188). Via this browser, the system connects to the Internet (step 190) or other remote network, and the accesses the testing server (step 192), either directly or indirectly, such as through a proxy server, as mentioned above. The testing process can then proceed, as described herein.

The invention thus provides a secure solution for high stakes testing or assessment. The system and method uses specialized software, such as provided by a boot CD or other method, to configure a workstation to administer a secure online test. The specialized software can be a stripped down operating system (e.g. Linux) with nothing but a browser that provides limited Internet access. The specialized operating system software can allow use of the Internet that is limited to a specific IP range or address, SSL encryption, a date window and access only to the secure testing server. This system will pre-empt the usual operating system of a work system to provide a basic operating system of its own, and the browser allows access to a back-end testing server via the Internet.

Advantageously, this system and method provide a “low touch” model at the workstation level. In other words, it does not require that a technician “touch” every station to add software, adjust the workstation, or take other actions. Instead, the test taker can put the boot CD into the workstation and turn on the system themselves. This reduces the expense and effort required by the test administrator to administer the test, yet allows the testing to remain secure.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A system for administering a standard test to be taken during a testing session by a remote user at a personal workstation having access to a communication network, the system comprising:
(a) a testing website maintained by the sponsor of the standard test and being accessible through the communication network;
(b) a secure server at the testing website, the secure server being dedicated to supplying inquiries from the standard test through the communication network to the remote user and to processing responses to the inquiries provided by the remote user through the communication network; and
(c) computer software provided to the remote user by the sponsor of the standard test in advance of the testing session, the computer software being receivable in the personal workstation at the convenience of the remote user to initiate the testing session, and the computer software preempting operation of the personal workstation for any purpose other than to enable the remote user to participate in the administration of the standard test.

2. A system as recited in claim 1, wherein the computer software comprises:
(a) a boot up program capable of deactivating preexisting computer software on the personal workstation during the testing session;
(b) a substitute operating system program for the personal workstation during the testing session; and
(b) a contact program targeted to a preselected location accessible through the communication network and corresponding to the secure server.

3. A system as recited in claim 2, wherein the preselected location comprises an internet address for the secure server.

4. A system as recited in claim 2, wherein the preselected location comprises a local area network address for the secure server.

5. A system as recited in claim 2, wherein the substitute operating system program is an open source operating system program.

6. A system as recited in claim 1, wherein the computer software is single-use computer software.

7. A system as recited in claim 1, wherein the computer software is functional only within a predetermined testing window applicable to the standard test.

8. A system as recited in claim 1, wherein the computer software is functional only for the duration of a predetermined testing window applicable to the standard test.

9. A system as recited in claim 1, wherein the computer software is embodied in a fixed medium.

10. A system as recited in claim 1, wherein the computer software is transmittable through the communication network.

11. A system as recited in claim 1, wherein the communication network comprises a multiple user interfacing system selected from the group of multiple user interfacing system comprising a local area network and an internet.

12. A computer system for administering a standard test to be taken during a testing session by a remote user at a personal workstation having access to a communication network, the system comprising:
(a) a secure server accessible through the communication network, the secure server being dedicated to supplying inquiries from the standard test to the remote user and to processing responses of the remote user to the inquiries;
(b) means for deactivating preexisting computer software on the personal workstation during the testing session;
(c) means for operating the personal workstation during the testing session; and
(d) means for contacting the secure server from the personal workstation during the testing session.

13. A system as recited in claim 12, wherein the means for deactivating the preexisting computer software comprises a boot up computer program.

14. A system as recited in claim 12, wherein the means for operating the personal workstation comprises an open source computer operating system program.

15. A system as recited in claim 12, wherein the means for contacting the secure server comprises a web browser program targeted to an internet address for the secure server.

16. A system as recited in claim 12, wherein the means for contacting the secure server comprises a local area network program targeted to a local area network address for the secure server.

17. A system as recited in claim 12, wherein the means for operating the personal workstation, the means for deactivating the preexisting computer software, and the means for contacting the secure server are embodied in a fixed medium, and the fixed medium is delivered to the remote user by the sponsor of the standard test in advance of the testing session.

18. A system as recited in claim 17, wherein the fixed medium is enterable into the personal workstation at the convenience of the remote user to initiate the testing session.

19. A system as recited in claim 17, wherein the fixed medium further embodies mean for rendering the fixed medium functional for a single use.

20. A system as recited in claim 17, wherein the fixed medium further embodies means for rendering the fixed medium functional only within a predetermined testing window applicable to the standard test and only for the duration of a predetermined testing window applicable to the standard test.

21. A system as recited in claim 12, wherein the means for operating the personal workstation, the means for deactivating the preexisting computer software, and the means for contacting the secure server comprise computer software transmittable through the communication network.

22. A method for administering a standard test to be taken during a testing session by a remote user at a personal workstation having access to a communication network, the method comprising the steps of:
(a) maintaining a secure server accessible through the communication network, the secure server being dedicated to supplying inquiries from the standard test to the remote user and to processing responses of the remote user to the inquiries;
(b) enrolling the remote user to receive and to respond at the personal workstation to the inquiries from the standard test during the testing secession; and
(c) supplying to the remote user in advance of the testing session computer software receivable into the personal workstation at the convenience of the remote user to initiate the testing session, the computer software being capable of preempting operation of the personal workstation for any purpose other than to enable the remote user to participate in the administration of the standard test.

23. A method as recited in claim 22, wherein the computer software comprises:
(a) a boot up program capable during the testing session of deactivating preexisting software on the personal workstation;
(b) a substitute operating system program for the personal workstation during the testing session; and
(b) a contact program targeted to a preselected location accessible through the communication network and corresponding to the secure server.

24. A method as recited in claim 23, wherein the computer software further comprises a calendar program capable of disabling the boot up program, the substitute operating system program, and the contact program outside of a predetermined testing window applicable to the standard test.

25. A method as recited in claim 23, wherein the computer software further comprises a clock program capable of disabling the boot up program, the substitute operating system program, and the contact program following the expiration of a predetermined testing window applicable to the standard test.

26. A method as recited in claim 23, wherein the preselected location corresponding to the secure server comprises an internet address for the secure server.

27. A method as recited in claim 23, wherein the preselected location corresponding to the secure server comprises a local area network address for the secure server.

28. A method as recited in claim 22, wherein the computer software is embodied in a fixed medium, and the step of supplying comprises the step of delivering the fixed medium to the remote user.

29. A method as recited in claim 22, wherein the computer software is transmittable through the communication network, and the step of delivering comprises the step of sending the computer software to the remote user through the communication network.

30. A method as recited in claim 22, further comprising the steps of:
(a) providing the remote user through the communication network with the inquiries from the standard test during the testing secession;
(b) receiving through the communication network responses of the remote user to the inquiries from the standard test;
(c) evaluating the responses of the remote user to the inquiries from the standard test; and
(d) reporting the results of the step of evaluating.
